(19) United States
(12) Patent Application Publication
(10) Pub. No.: US 2025/0125086 A1
(43) Pub. Date: Apr. 17, 2025

(54) COIL DEVICE

(71) Applicant: TDK Corporation, Tokyo (JP)

(72) Inventors: Riku UMEKI, Tokyo (JP); Kiyofumi Fujiwara, Tokyo (JP); Satoshi Sugimoto, Tokyo (JP)

(73) Assignee: TDK Corporation, Tokyo (JP)

(21) Appl. No.: 18/916,944

(22) Filed: Oct. 16, 2024

(30) Foreign Application Priority Data
Oct. 17, 2023 (JP) 2023-179038

(51) Int. Cl. H01F 27/30; H01F 3/14; H01F 37/00

(52) U.S. Cl. CPC H01F 27/306; H01F 3/14; H01F 37/00

(57) ABSTRACT

A core device includes: a core having a mounting surface; a first conductor including a first body portion extending along the mounting surface inside the core; and a second conductor including a second body portion that extends along the mounting surface inside the core and faces the first body portion. The first body portion has a first side surface having a first thickness in a direction perpendicular to the mounting surface and a first main surface having a first width in a direction parallel to the mounting surface. The second body portion has a second side surface having a second thickness in the direction perpendicular to the mounting surface and a second main surface having a second width in the direction parallel to the mounting surface. The second width is narrower than the first width when the first body portion and the second body portion face each other.

### BACKGROUND OF THE INVENTION

### Field of the Invention

The present disclosure relates to a coil device that can be used as, for example, a coupling inductor.

### Description of the Related Art

For example, in a power supply circuit of a server, a coil device called a coupling inductor may be used in order to improve a response speed of a voltage regulator or to reduce the number of components in the power supply circuit. As a coil device of this type, U.S. Patent Application Publication No. 2018/0068778 (Patent Literature 1) discloses a coil device including a core, a first winding including a first intermediate portion having a flat surface, and a second winding including a second intermediate portion having a flat surface. The first intermediate portion and the second intermediate portion face each other at a predetermined interval and are magnetically coupled to each other.

In the coil device according to Patent Literature 1, the first intermediate portion and the second intermediate portion are disposed parallel to a side surface (a surface perpendicular to a mounting surface) of the core. By disposing the first intermediate portion and the second intermediate portion inside the core in such an orientation, a size of the core is reduced, and a downsized and lower-profile coupling inductor can be achieved.

In recent years, in order to further improve the response speed of the voltage regulator, there has been a demand for a coupling inductor that is not only smaller in size but also has higher performance. In order to improve the response speed of the voltage regulator, it is necessary to further improve the inductance property and/or the DC superimposition property of the coupling inductor in particular.
Patent Document 1: U.S. Patent Application Publication No. 2018/0068778

### SUMMARY OF THE INVENTION

The present disclosure is made in view of such circumstances, and an object thereof is to provide a coil device excellent in inductance property and/or DC superimposition property.

In order to achieve the above object, a coil device according to the present disclosure includes:
a core having a mounting surface;
a first conductor including a first body portion extending along the mounting surface inside the core; and
a second conductor including a second body portion that extends along the mounting surface inside the core and faces the first body portion, in which
the first body portion has a first side surface having a first thickness in a direction perpendicular to the mounting surface and a first main surface having a first width in a direction parallel to the mounting surface,
the second body portion has a second side surface having a second thickness in the direction perpendicular to the mounting surface and a second main surface having a second width in the direction parallel to the mounting surface, and
the second width is narrower than the first width in a direction in which the first body portion and the second body portion face each other.

In the coil device according to the present disclosure, the first body portion has the first side surface having the first thickness in the direction perpendicular to the mounting surface and the first main surface having the first width in the direction parallel to the mounting surface. The second body portion has the second side surface having the second thickness in the direction perpendicular to the mounting surface and the second main surface having the second width in the direction parallel to the mounting surface. By disposing the first body portion and the second main portion inside the core such that the orientations of the first side surface, the second side surface, the first main surface and the second main surface are as described above, a size of the core is reduced, and a downsized and lower-profile coil device can be achieved. Since the first body portion and the second body portion face each other, magnetic coupling between the first body portion and the second body portion can be ensured.

In particular, in the coil device according to the present disclosure, the second width is narrower than the first width in the direction in which the first body portion and the second body portion face each other. Therefore, as compared with a case in which the first width and the second width are equal to each other, a larger space (a space corresponding to a difference between the first width and the second width) for disposing the core is formed around the second body portion. Accordingly, a volume of the core is increased around the second body portion, and an inductance property and/or a DC superimposition property of the coil device are improved. Since the first width and the second width are different, the first body portion and the second body portion have different resistance values. Accordingly, the inductance property and/or the DC superimposition property of the coil device can be adjusted according to the resistance value of the first body portion or the second body portion.

The first side surface and the second side surface may be perpendicular to the mounting surface. In this case, the first side surface and the second side surface can be disposed parallel to the side surface (a surface perpendicular to the mounting surface) of the core. Accordingly, a larger space for disposing the core can be formed around the first side surface and the second side surface. Therefore, the inductance property and/or the DC superimposition property of the coil device are further improved.

The first conductor may include a first mounting portion continuous with the first body portion, the second conductor may include a second mounting portion continuous with the second body portion, and a cross-sectional area of the first mounting portion or the second mounting portion may be larger than a cross-sectional area of the second body portion and equal to or smaller than a cross-sectional area of the first body portion. In this case, a contact area between the first mounting portion or the second mounting portion and a mounting substrate can be secured. Therefore, mounting stability of the coil device is improved.

The first mounting portion may have a third width in an axial direction of the first body portion and a fourth width in the direction in which the first body portion and the second body portion face each other, the first thickness, the second thickness, and the fourth width may be equal, the first thickness, the second thickness, and the fourth width may be larger than the second width and equal to or smaller than the third width, and the third width may be larger than or equal to the first thickness, the second thickness, and the fourth width and equal to or smaller than the first width. In particular, when the third width and the fourth width satisfy the above magnitude relation, the contact area between the first mounting portion and the mounting substrate is easily secured, and mounting stability of the coil device is improved. In particular, when the first width and the second width satisfy the above magnitude relation, the volume of the core around the second body portion is easily secured, and the inductance property and/or the DC superimposition property of the coil device are improved.

The first mounting portion may have a third width in an axial direction of the first body portion and a fourth width in the direction in which the first body portion and the second body portion face each other, the second mounting portion may have a fifth width in an axial direction of the second body portion and a sixth width in the direction in which the first body portion and the second body portion face each other, the third width may be equal to the fifth width, and the fourth width may be equal to the sixth width. In this case, the cross-sectional area of the first mounting portion is equal to the cross-sectional area of the second mounting portion. Therefore, when the first mounting portion and the second mounting portion are disposed on the mounting substrate, mounting stability of the coil device is improved.

The first body portion and the second body portion may constitute a magnetic coupling portion magnetically coupled to each other, and a center portion of the magnetic coupling portion may be positioned at a center portion of the core in the direction in which the first body portion and the second body portion face each other. In this case, in the periphery of the first body portion and the periphery of the second body portion, the balance of the volume of the core is improved, and a saturation magnetic flux density of the core is easily made uniform.

A ratio of the first width to the second width may be 3:1 to 4:1. In this case, the inductance property and/or the DC superimposition property of the coil device are particularly improved.

The first conductor may include a first mounting portion continuous with the first body portion and exposed from the core, the second conductor may include a second mounting portion continuous with the second body portion and exposed from the core, and the first mounting portion and the second mounting portion may extend to a mounting surface side of the core while being separated from each other along the direction in which the first body portion and the second body portion face each other. Since the first mounting portion and the second mounting portion are separated from each other along the direction in which the first body portion and the second body portion face each other, the size of the coil device is reduced in the axial direction of the first body portion or the second body portion. Accordingly, the coil device can be downsized.

The first mounting portion may include a first base end portion extending along the direction in which the first body portion and the second body portion face each other, and a first leg portion continuous with the first base end portion and extending toward the mounting surface, the second mounting portion may include a second base end portion extending toward a side opposite to the first base end portion along the direction in which the first body portion and the second body portion face each other, and a second leg portion continuous with the second base end portion and extending toward the mounting surface, the first mounting portion may be curved in an L-shape from the first base end portion to the first leg portion, and the second mounting portion may be curved in an L-shape from the second base end portion to the second leg portion. In this case, since the first base end portion and the second base end portion extend to opposite sides along the direction in which the first body portion and the second body portion face each other, the size of the coil device can be reduced in the axial direction of the first body portion or the second body portion. In addition, since the first mounting portion and the second mounting portion are curved in an L-shape, mounting stability is improved when the coil device is mounted.

### BRIEF DESCRIPTION OF THE DRAWINGS

FIG. 1 is a perspective view of a coil device according to an embodiment of the present disclosure;

FIG. 2 is a perspective view of a first core illustrated in FIG. 1;

FIG. 3 is an exploded perspective view of the coil device illustrated in FIG. 1;

FIG. 4 is a perspective view of a first conductor and a second conductor illustrated in FIG. 1;

FIG. 5 is a cross-sectional view of the coil device illustrated in FIG. 1 taken along a line V-V; and

FIG. 6 is a plan view of the first core to which the first conductor and the second conductor illustrated in FIG. 3 are attached.

### DETAILED DESCRIPTION OF THE PREFERRED EMBODIMENTS

Hereinafter, an embodiment of the present disclosure will be described with reference to the drawings. The illustrated contents are merely schematically and exemplarily illustrated for the purpose of understanding the present disclosure, and the appearance, the dimensional ratio, and the like may be different from those of an actual object. The present disclosure is not limited to the following embodiment.

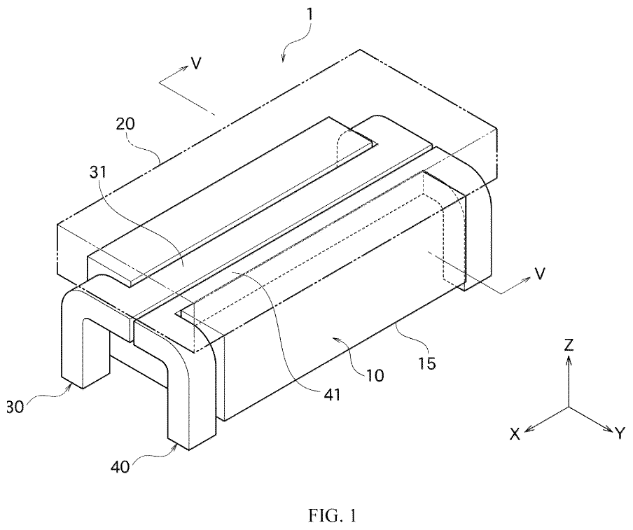

A coil device 1 illustrated in FIG. 1 functions as a coupling inductor, and is provided, for example, in a power supply circuit of a server. The coil device 1 includes a first core 10, a second core 20, a first conductor 30, and a second conductor 40. A core according to the present embodiment is constituted by two cores of the first core 10 and the second core 20, but the core may be constituted by one core, or three or more cores.

In FIGS. 1 to 6, an X axis is an axis along an axial direction of the first conductor 30 (a first body portion 31) or the second conductor 40 (a second body portion 41). A Y axis is an axis along a direction in which the first conductor 30 and the second conductor 40 face each other. A Z axis is an axis perpendicular to the X axis and the Y axis. The X axis, the Y axis, and the Z axis are perpendicular to each other. Hereinafter, for each of the X axis, the Y axis, and the Z axis, a direction away from a center of the coil device 1 is referred to as “outside”, and a direction approaching the center of the coil device 1 is referred to as “inside”. A positive direction side of the Z axis is referred to as “upper side”, and a negative direction side of the Z axis is referred to as “lower side”. However, the upper side in a Z-axis direction does not necessarily coincide with an upper side in a vertical direction. The lower side in the Z-axis direction does not necessarily coincide with a lower side in the vertical direction.

A width of the coil device 1 in an X-axis direction is not particularly limited, and is, for example, 2.0 mm to 20.0 mm. A width of the coil device 1 in a Y-axis direction is not particularly limited, and is, for example, 2.0 mm to 10.0 mm. A thickness of the coil device 1 in the Z-axis direction is not particularly limited, and is 2.0 mm to 10.0 mm.

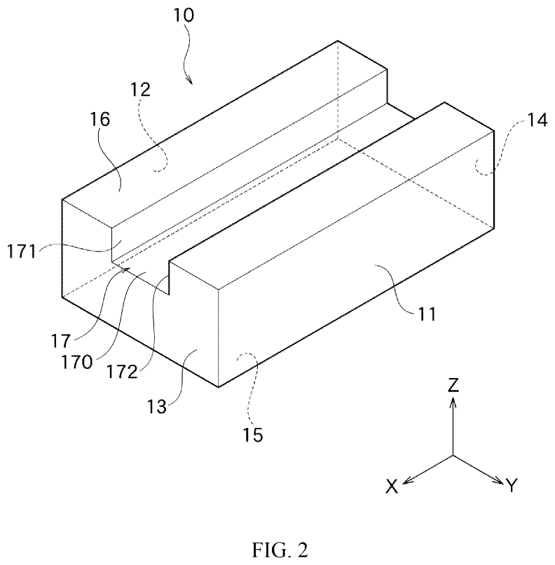

As illustrated in FIG. 2, the first core 10 has a first side surface 11, a second side surface 12, a third side surface 13, a fourth side surface 14, a mounting surface 15, and a mounting facing surface 16. The first side surface 11 and the second side surface 12 have the same shape and are positioned on opposite sides along the Y axis. The shape of the first side surface 11 and the second side surface 12 is a rectangle, but may be a square or another polygon. The third side surface 13 and the fourth side surface 14 have the same shape and are positioned on opposite sides along the X axis. The mounting surface 15 and the mounting facing surface 16 are positioned on opposite sides along the Z axis.

The first core 10 has a groove 17 formed in the mounting facing surface 16. The groove 17 is positioned at a center in the Y-axis direction and extends along the X-axis from one end to the other end of the mounting facing surface 16 in the X-axis direction.

The groove 17 has a bottom surface 170 and inner walls 171 and 172. The bottom surface 170 is a flat surface parallel to the mounting surface 15. The inner walls 171 and 172 are surfaces perpendicular to the bottom surface 170. The inner wall 171 and the inner wall 172 face each other along the Y axis. In the present embodiment, the term “parallel” is not limited to strictly parallel. The term “perpendicular” is not limited to strictly perpendicular.

The first core 10 is made of a composite material containing a magnetic material and a resin. The first core 10 is formed by, for example, powder compaction, injection molding, or scraping. The magnetic material for the first core 10 is not particularly limited, and is, for example, ferrite (Ni—Zn ferrite, Mn—Zn ferrite, or the like) or a metal magnetic material. The resin for the first core 10 is not particularly limited, and is, for example, an epoxy resin or a phenol resin.

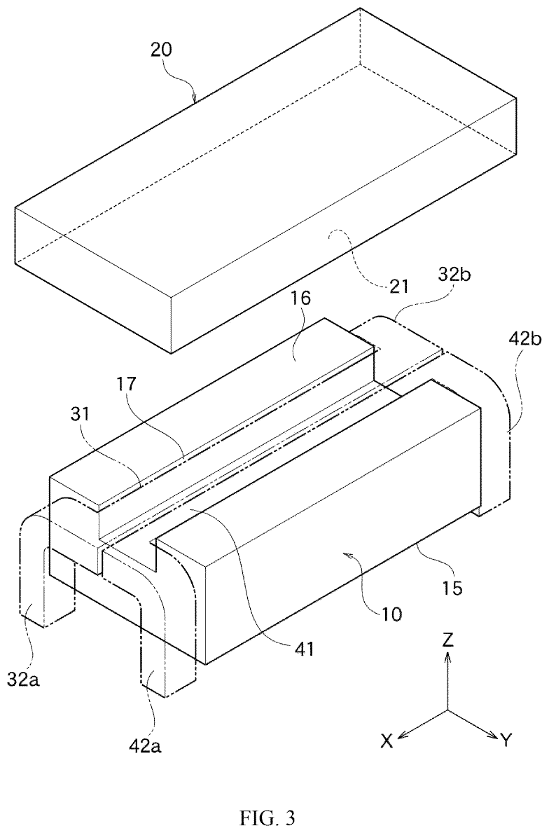

As illustrated in FIG. 3, the second core 20 has a rectangular parallelepiped shape. The second core 20 is formed by, for example, powder compaction, injection molding, or scraping. The second core 20 has a contact surface 21 that contacts the mounting facing surface 16 of the first core 10. The second core 20 (the contact surface 21) is bonded to the first core 10 (the mounting facing surface 16) by, for example, an adhesive.

A material for the second core 20 may be the same as or different from the material for the first core 10. A relative permeability of the second core 20 may be the same as or different from a relative permeability of the first core 10.

A width of the second core 20 in the X-axis direction is not particularly limited, and is wider than a width of the first core 10 in the X-axis direction. A width of the second core 20 in the Y-axis direction is not particularly limited, and is equal to a width of the first core 10 in the Y-axis direction. A thickness of the second core 20 in the Z-axis direction is not particularly limited, and is thinner than a thickness of the first core 10 in the Z-axis direction.

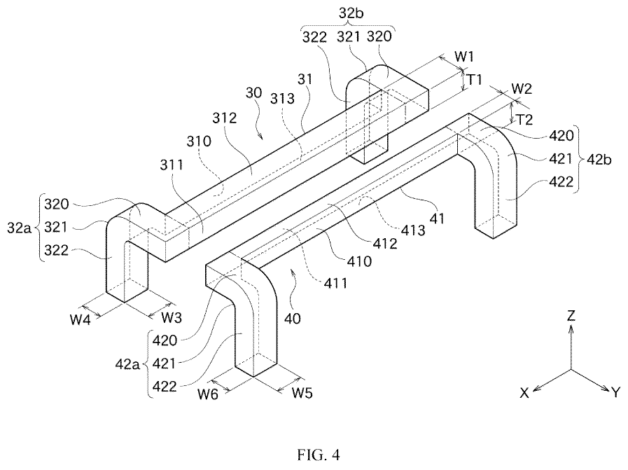

The first conductor 30 and the second conductor 40 illustrated in FIG. 4 are formed of a metal frame. The first conductor 30 and the second conductor 40 are formed by, for example, machining (for example, punching, bending, cutting, pressing, sheet metal working, casting, or forging) a metal plate (a conductor plate) or a metal piece (a conductor piece) into the shapes illustrated in FIG. 4. The first conductor 30 and the second conductor 40 have higher rigidity than a general wire (a round wire, a rectangular wire, or the like). A material for the first conductor 30 and the second conductor 40 is not particularly limited, and is, for example, copper, a copper alloy, silver, or nickel.

A plating film (a plating layer) is formed on at least a part (the entire surface in the present embodiment) of the first conductor 30. A plating film (a plating layer) is formed on at least a part (the entire surface in the present embodiment) of the second conductor 40. The plating film may be constituted by a single layer or a plurality of layers. The plating film is not particularly limited, and examples thereof include Cu plating, Ni plating, Sn plating, Ni—Sn plating, Cu—Ni—Sn plating, Ni—Au plating, and Au plating.

The first conductor 30 is a primary coil, and the second conductor 40 is a secondary coil. However, the first conductor 30 may be a secondary coil, and the second conductor 40 may be a primary coil. The first conductor 30 and the second conductor 40 constitute a coupling coil magnetically coupled to each other.

As illustrated in FIG. 4, the first conductor 30 includes the first body portion 31 and first mounting portions 32a and 32b. The first body portion 31 is elongated along the X axis and extends linearly. A cross-sectional shape of the first body portion 31 is a rectangle, but may be a square, another polygon, or another shape.

The first body portion 31 has two side surfaces (first side surfaces) and two main surfaces (first main surfaces). The first body portion 31 has a first outer side surface 310 and a first inner side surface 311 as the first side surfaces. The first body portion 31 has a first top surface 312 and a first bottom surface 313 as the first main surfaces.

The first outer side surface 310 and the first inner side surface 311 are positioned on opposite sides along the Y axis and are parallel to each other. The first outer side surface 310 is positioned further outward in the Y-axis direction than the first inner side surface 311. The first top surface 312 and the first bottom surface 313 are positioned on opposite sides along the Z axis, and are parallel to each other. The first outer side surface 310, the first inner side surface 311, the first top surface 312, and the first bottom surface 313 are flat surfaces perpendicular to each other.

However, at least one of the first outer side surface 310, the first inner side surface 311, the first top surface 312, and the first bottom surface 313 may not be a flat surface, and may be, for example, an inclined surface, an uneven surface, a curved surface, or a bent surface. For example, the first outer side surface 310 according to the present embodiment is perpendicular to an XY plane (that is, the mounting surface 15 in FIG. 3), but may be an inclined surface inclined at a predetermined angle (for example, 30° or more and less than) 90° with respect to the mounting surface 15.

The first mounting portion 32a is continuous with one end of the first body portion 31 in the axial direction, and the first mounting portion 32b is continuous with the other end of the first body portion 31 in the axial direction. In FIG. 4, a boundary between the first body portion 31 and the first mounting portion 32a and a boundary between the first body portion 31 and the first mounting portion 32b are indicated by one-dot chain lines. A shape of the first mounting portion 32a is the same as a shape of the first mounting portion 32b, but may be different.

The first mounting portions 32a and 32b each have a shape bent in an L-shape. The first mounting portions 32a and 32b are connected to a mounting substrate by solder, a conductive adhesive, or the like. Each of the first mounting portions 32a and 32b includes a base end portion 320, a curved portion 321, and a leg portion 322.

The base end portion 320 is continuous with the first body portion 31 and extends along the Y axis so as to be orthogonal to the first body portion 31. The curved portion 321 is curved in an L-shape between the base end portion 320 and the leg portion 322. The leg portion 322 linearly extends along the Z axis. The leg portion 322 is orthogonal to the base end portion 320. As viewed in the X-axis direction, the leg portion 322 is positioned further outward in the Y-axis direction than the first body portion 31. A cross-sectional shape of the leg portion 322 is a rectangle, but may be a square, another polygon, or another shape.

The second conductor 40 includes the second body portion 41 and second mounting portions 42a and 42b. The second body portion 41 is elongated along the X axis and extends linearly. A cross-sectional shape of the second body portion 41 is a rectangle, but may be a square, another polygon, or another shape.

The second body portion 41 has two side surfaces (second side surfaces) and two main surfaces (second main surfaces). The second body portion 41 has a second outer side surface 410 and a second inner side surface 411 as the second side surfaces. The second body portion 41 has a second top surface 412 and a second bottom surface 413 as the second main surfaces.

The second outer side surface 410 and the second inner side surface 411 are positioned on opposite sides along the Y axis and are parallel to each other. The second outer side surface 410 is positioned further outward in the Y-axis direction than the second inner side surface 411. The second top surface 412 and the second bottom surface 413 are positioned on opposite sides along the Z axis, and are parallel to each other. The second outer side surface 410, the second inner side surface 411, the second top surface 412, and the second bottom surface 413 are flat surfaces perpendicular to each other.

However, at least one of the second outer side surface 410, the second inner side surface 411, the second top surface 412, and the second bottom surface 413 may not be a flat surface, and may be, for example, an inclined surface, an uneven surface, a curved surface, or a bent surface. For example, the second outer side surface 410 according to the present embodiment is perpendicular to the XY plane (that is, the mounting surface 15 in FIG. 3), but may be an inclined surface inclined at a predetermined angle (for example, 30° or more and less than) 90° with respect to the mounting surface 15.

The second mounting portion 42a is continuous with one end of the second body portion 41 in the axial direction, and the second mounting portion 42b is continuous with the other end of the second body portion 41 in the axial direction. In FIG. 4, a boundary between the second body portion 41 and the second mounting portion 42a and a boundary between the second body portion 41 and the second mounting portion 42b are indicated by one-dot chain lines. A shape of the second mounting portion 42a is the same as a shape of the second mounting portion 42b, but may be different.

The second mounting portions 42a and 42b each have a shape bent in an L-shape. The second mounting portions 42a and 42b are connected to the mounting substrate by solder, a conductive adhesive, or the like. Each of the second mounting portions 42a and 42b includes a base end portion 420, a curved portion 421, and a leg portion 422.

The base end portion 420 is continuous with the second body portion 41 and extends along the Y axis so as to be orthogonal to the second body portion 41. The curved portion 421 is curved in an L-shape between the base end portion 420 and the leg portion 422. The leg portion 422 linearly extends along the Z axis. The leg portion 422 is orthogonal to the base end portion 420. As viewed in the X-axis direction, the leg portion 422 is positioned further outward in the Y-axis direction than the second body portion 41. A cross-sectional shape of the second body portion 422 is a rectangle, but may be a square, another polygon, or another shape.

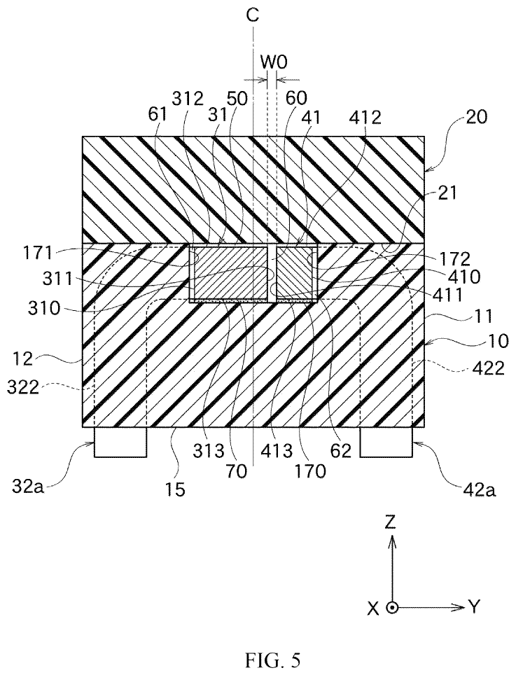

As illustrated in FIG. 3, the first body portion 31 and the second body portion 41 are disposed inside the groove 17. The first body portion 31 extends along the mounting surface 15 inside the groove 17. The second body portion 41 extends parallel to the first body portion 31 along the mounting surface 15 inside the groove 17. A depth of the groove 17 is equal to or larger than a thickness of the first body portion 31 or the second body portion 41 in the Z-axis direction so that the first body portion 31 and the second body portion 41 are not exposed from the groove 17. As illustrated in FIG. 5, the first bottom surface 313 of the first body portion 31 is bonded to the bottom surface 170 of the groove 17 with an adhesive 70. The second bottom surface 413 of the second body portion 41 is bonded to the bottom surface 170 of the groove 17 with the adhesive 70. However, the first top surface 312 of the first body portion 31 may be bonded to the contact surface 21 of the second core 20 by the adhesive 70. The second top surface 412 of the second body portion 41 may be bonded to the contact surface 21 of the second core 20 by the adhesive 70.

The first inner side surface 311 and the second inner side surface 411 face each other along the Y axis at a predetermined interval. An interval W0 along the Y axis between the first inner side surface 311 and the second inner side surface 411 is not particularly limited, and is, for example, 0.05 mm to 0.5 mm. The magnetic coupling between the first body portion 31 and the second body portion 41 can be adjusted according to a size of the interval W0. A gap 60 is formed between the first inner side surface 311 and the second inner side surface 411.

The gap 60 is an air gap. However, the gap 60 may be filled with an adhesive. For example, in order to set the interval W0 to a predetermined value, the first inner side surface 311 and the second inner side surface 411 may be bonded to each other by an adhesive (for example, an adhesive containing beads). Alternatively, a part of the first core 10 or the second core 20 may be disposed in the gap 60. Alternatively, a partition member (a spacer) or a film body (a film) formed of a non-conductive member such as a resin may be disposed in the gap 60.

Although a gap 61 is formed between the first outer side surface 310 and the inner wall 171 of the groove 17, the first outer side surface 310 may be in contact with the inner wall 171. Alternatively, the first outer side surface 310 and the inner wall 171 may be bonded to each other with an adhesive.

Although a gap 62 is formed between the second outer side surface 410 and the inner wall 172 of the groove 17, the second outer side surface 410 may be in contact with the inner wall 172. Alternatively, the second outer side surface 410 and the inner wall 172 may be bonded to each other with an adhesive.

The first body portion 31 and the second body portion 41 are accommodated in a space defined by the groove 17 so as to be sandwiched between the first core 10 and the second core 20 from above and below. A gap is formed between the first top surface 312 of the first body portion 31 and the contact surface 21 of the second core 20, but the first top surface 312 and the contact surface 21 may be in contact with each other. A gap is formed between the second top surface 412 of the second body portion 41 and the contact surface 21 of the second core 20, but the second top surface 412 and the contact surface 21 may be in contact with each other.

The first body portion 31 and the second body portion 41 constitute a magnetic coupling portion 50 that is magnetically coupled to each other. The magnetic coupling portion 50 is a virtual structure in which the first body portion 31 and the second body portion 41 are regarded as one configuration. In the Y-axis direction, a center C of the magnetic coupling portion 50 is positioned at the center of the first core 10 and/or the second core 20. However, the position of the center C of the magnetic coupling portion 50 in the Y-axis direction may not completely coincide with the position of the center of the first core 10 and/or the second core 20 in the Y-axis direction. The center C of the magnetic coupling portion 50 may be positioned within a range of a predetermined length along the Y axis from the center of the first core 10 and/or the second core 20. The predetermined length is 5% of the width of the first core 10 or the second core 20 in the Y-axis direction.

In the present embodiment, a center portion of the magnetic coupling portion 50 is positioned at a center portion of the first core 10. Therefore, the balance of a volume of the first core 10 is improved and a saturation magnetic flux density of the first core 10 is easily made uniform in the periphery of the first body portion 31 (for example, the outside of the first outer side surface 310 in the Y-axis direction) and the periphery of the second body portion 41 (for example, the outside of the second outer side surface 410 in the Y-axis direction).

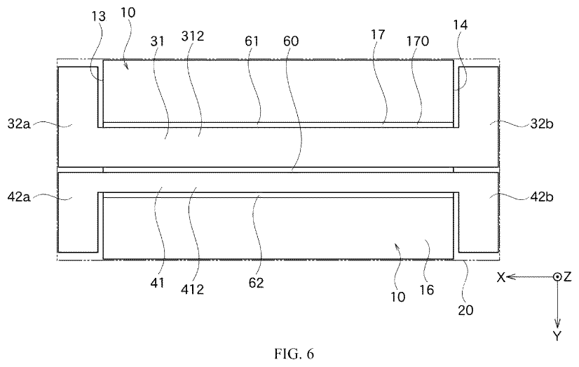

As illustrated in FIG. 6, the first mounting portion 32a is disposed outside the first core 10 in the X-axis direction and is adjacent to the third side surface 13. The first mounting portion 32b is disposed outside the first core 10 in the X-axis direction and is adjacent to the fourth side surface 14. The first mounting portions 32a and 32b are disposed on both sides of the first core 10 in the X-axis direction so as to sandwich the first core 10 from both sides in the X-axis direction.

The first mounting portions 32a and 32b are exposed from the first core 10 and the second core 20. The first mounting portions 32a and 32b are covered from above by the second core 20 indicated by a two-dot chain line in FIG. 6. Therefore, as viewed from above, the first mounting portions 32a and 32b are hidden by the second core 20.

The second mounting portion 42a is disposed outside the first core 10 in the X-axis direction and is adjacent to the third side surface 13. The second mounting portion 42b is disposed outside the first core 10 in the X-axis direction and is adjacent to the fourth side surface 14. The second mounting portions 42a and 42b are disposed on both sides of the first core 10 in the X-axis direction so as to sandwich the first core 10 from both sides in the X-axis direction.

The second mounting portions 42a and 42b are exposed from the first core 10 and the second core 20. The second mounting portions 42a and 42b are covered from above by the second core 20 indicated by a two-dot chain line in FIG. 6. Therefore, as viewed from above, the second mounting portions 42a and 42b are hidden by the second core 20.

As illustrated in FIG. 5, as viewed in the X-axis direction, the leg portion 322 of the first mounting portion 32a is positioned further inward in the Y-axis direction than the second side surface 12 of the first core 10. Although not illustrated in detail, the same applies to the leg portion 322 of the first mounting portion 32b. As viewed in the X-axis direction, the leg portion 422 of the second mounting portion 42a is positioned further inward in the Y-axis direction than the first side surface 11 of the first core 10. Although not illustrated in detail, the same applies to the leg portion 422 of the second mounting portion 42b.

A lower portion of the leg portion 322 protrudes downward beyond the mounting surface 15 of the first core 10. A lower portion of the leg portion 422 protrudes downward beyond the mounting surface 15 of the first core 10. Therefore, the mounting surface 15 is positioned above bottom surfaces of the leg portions 322 and 422.

As illustrated in FIGS. 4 and 5, the first outer side surface 310 has a first thickness T1 in a direction (the Z-axis direction) perpendicular to the XY plane (the mounting surface 15). The first inner side surface 311 also has the first thickness T1 in the same direction. The first top surface 312 has a first width W1 in a direction (the Y-axis direction) parallel to the XY plane (the mounting surface 15). The first bottom surface 313 also has the first width W1 in the same direction.

The second outer side surface 410 has a second thickness T2 in the direction (the Z-axis direction) perpendicular to the XY plane (the mounting surface 15). The second inner side surface 411 also has the second thickness T2 in the same direction. The second top surface 412 has a second width W2 in the direction (the Y-axis direction) parallel to the XY plane (the mounting surface 15). The second bottom surface 413 also has the second width W2 in the same direction.

The second width W2 is narrower than the first width W1 in a direction (the Y-axis direction) in which the first body portion 31 and the second body portion 41 face each other. Therefore, as compared with a case in which the first width W1 and the second width W2 are equal to each other, a larger space (a space corresponding to the difference between the first width W1 and the second width W2) for disposing the first core 10 is formed around the second body portion 41. Accordingly, the volume of the first core 10 is increased around the second body portion 41 (for example, the outside of the second outer side surface 410 in the Y-axis direction), and the inductance property and/or the DC superimposition property of the coil device 1 are improved.

Since the first width W1 and the second width W2 are different, the first body portion 31 and the second body portion 41 have different resistance values. Accordingly, the inductance property and/or the DC superimposition property of the coil device 1 can be adjusted according to the resistance value of the first body portion 31 or the second body portion 41.

By disposing the first body portion 31 and the second body portion 41 inside the first core 10 such that the orientations are as illustrated in FIGS. 4 and 5, the size of the first core 10 is reduced, and the coil device 1 can be made downsized and lower-profile. Since the first body portion 31 and the second body portion 41 face each other, magnetic coupling between the first body portion 31 and the second body portion 41 can be ensured.

A ratio of the first width W1 to the second width W2 is not particularly limited, and is 2:1 to 5:1 or 3:1 to 4:1. In this case, the inductance property and/or the DC superimposition property of the coil device 1 are particularly improved.

Both the first outer side surface 310 and the second outer side surface 410 are perpendicular to the mounting surface 15. Therefore, the first outer side surface 310 is disposed parallel to the second side surface 12 (a surface perpendicular to the mounting surface 15) of the first core 10. The second outer side surface 410 is disposed parallel to the first side surface 11 (a surface perpendicular to the mounting surface 15) of the first core 10. Accordingly, a larger space for disposing the first core 10 can be formed around the first outer side surface 310 and the second outer side surface 410. Therefore, the inductance property and/or the DC superimposition property of the coil device 1 are further improved.

The first mounting portion 32a (the leg portion 322) has a third width W3 along the axial direction (the X-axis direction) of the first body portion 31. The first mounting portion 32a (the leg portion 322) has a fourth width W4 along the direction (the Y-axis direction) in which the first body portion 31 and the second body portion 41 face each other. The first mounting portion 32b also has the third width W3 and the fourth width W4 in the same directions.

The second mounting portion 42a (the leg portion 422) has a fifth width W5 along the axial direction (the X-axis direction) of the second body portion 41. The second mounting portion 42b (the leg portion 422) has a sixth width W6 along the direction (the Y-axis direction) in which the first body portion 31 and the second body portion 41 face each other. The second mounting portion 42b also has the fifth width W5 and the sixth width W6 in the same directions.

The third width W3 is equal to the fifth width W5. The fourth width W4 is equal to the sixth width W6. Therefore, a cross-sectional area of the first mounting portion 32a is equal to a cross-sectional area of the second mounting portion 42a. Accordingly, when the first mounting portion 32a and the second mounting portion 42a are disposed on the mounting substrate, mounting stability of the coil device 1 is improved.

The first thickness T1, the second thickness T2, and the fourth width W4 are equal. The first thickness T1, the second thickness T2, and the fourth width W4 are larger than the second width W2 and equal to or smaller than the third width W3. The third width W3 is larger than or equal to the first thickness T1, the second thickness T2, and the fourth width W4 and equal to or smaller than the first width W1. In particular, when the third width W3 and the fourth width W4 satisfy the above magnitude relation, a contact area between the first mounting portion 32a and the mounting substrate is easily secured, and mounting stability of the coil device 1 is improved. In particular, when the first width W1 and the second width W2 satisfy the above magnitude relation, the volume of the first core 10 around the second body portion 41 is easily secured, and the inductance property and/or the DC superimposition property of the coil device 1 are improved.

The first thickness T1, the second thickness T2, and the sixth width W6 are equal. The first thickness T1, the second thickness T2, and the sixth width W6 are larger than the second width W2 and equal to or smaller than the fifth width W5. The fifth width W5 is larger than or equal to the first thickness T1, the second thickness T2, and the sixth width W6 and equal to or smaller than the first width W1. In particular, when the fifth width W5 and the sixth width W6 satisfy the above magnitude relation, a contact area between the second mounting portion 42a and the mounting substrate is easily secured, and mounting stability of the coil device 1 is improved. In particular, when the first width W1 and the second width W2 satisfy the above magnitude relation, the volume of the first core 10 around the second body portion 41 is easily secured, and the inductance property and/or the DC superimposition property of the coil device 1 are improved.

The cross-sectional area (W3×W4) of the first mounting portion 32a is larger than a cross-sectional area (T2×W2) of the second body portion 41 and equal to or smaller than a cross-sectional area (T1×W1) of the first body portion 31. The same applies to a cross-sectional area of the first mounting portion 32b. The cross-sectional area (W5×W6) of the second mounting portion 42a is larger than the cross-sectional area (T2×W2) of the second body portion 41 and equal to or smaller than the cross-sectional area (T1×W1) of the first body portion 31. The same applies to a cross-sectional area of the second mounting portion 42b. Therefore, the contact area between the first mounting portion 32a and/or the second mounting portion 42a and the mounting substrate can be secured. Accordingly, mounting stability of the coil device 1 is improved.

As illustrated in FIG. 3, the first mounting portion 32a and the second mounting portion 42a extend to a mounting surface 15 side of the first core 10 while being separated from each other along the direction in which the first body portion 31 and the second body portion 41 face each other (that is, the Y-axis direction). The first mounting portion 32b and the second mounting portion 42b extend to the mounting surface 15 side of the first core 10 while being separated from each other along the direction in which the first body portion 31 and the second body portion 41 face each other (that is, the Y-axis direction). Since the first mounting portion 32a and the second mounting portion 42a are separated from each other along the Y-axis direction, the size of the coil device 1 is reduced in the axial direction (the X-axis direction) of the first body portion 31 or the second body portion 41. Accordingly, the coil device 1 can be downsized.

Next, a method for manufacturing the coil device 1 will be described. First, the first core 10, the second core 20, the first conductor 30, and the second conductor 40 illustrated in FIG. 3 are prepared. Next, the first bottom surface 313 (FIG. 4) of the first body portion 31 is bonded to the groove 17 of the first core 10 with an adhesive. The second bottom surface 413 (FIG. 4) of the second body portion 41 is bonded to the groove 17 with an adhesive. At this time, an interval is provided between the first body portion 31 and the second body portion 41 such that the gap 60 illustrated in FIG. 5 is formed between the first body portion 31 and the second body portion 41. As illustrated in FIG. 3, the first mounting portions 32a and 32b are disposed outside the first core 10 in the X-axis direction, and the second mounting portions 42a and 42b are disposed outside the first core 10 in the X-axis direction. Next, the contact surface 21 of the second core 20 illustrated in FIG. 3 is bonded to the mounting facing surface 16 of the first core 10 illustrated in FIG. 2 by an adhesive. As described above, the coil device 1 illustrated in FIG. 1 can be manufactured.

The present disclosure is not limited to the above embodiment, and various modifications can be made within the scope of the present disclosure.

For example, in the above embodiment, an application example of the present disclosure to the coupling inductor has been described, but the present disclosure may be applied to other electronic components.

As illustrated in FIG. 3, the core according to the above embodiment is constituted by two cores of the first core 10 and the second core 20, but the core may be constituted by one core. Such a core can be formed by, for example, (1) placing the first conductor 30 and the second conductor 40 in a press mold, (2) filling a core material for the core in the press mold, and (3) compressing and curing the core material.

As illustrated in FIG. 3, in the above embodiment, the groove 17 for accommodating the first body portion 31 and the second body portion 41 is formed in the first core 10. However, the groove for accommodating the first body portion 31 and the second body portion 41 may be formed in the second core 20.

As long as the second width W2 illustrated in FIG. 4 is smaller than the first width W1, dimensions of the first conductor 30 and the second conductor 40 are not particularly limited. For example, in the above embodiment, the first thickness T1, the second thickness T2, and the fourth width W4 are equal to each other, but the first thickness T1 and the second thickness T2 may be different from the fourth width W4. The first thickness T1 and the second thickness T2 may be different from each other. Also in this case, the same effects as those of the above embodiment can be achieved.

In the above embodiment, the first thickness T1, the second thickness T2, and the fourth width W4 are larger than the second width W2 and equal to or smaller than the third width W3, but the first thickness T1, the second thickness T2, and the fourth width W4 may be equal to or smaller than the second width W2. The first thickness T1, the second thickness T2, and the fourth width W4 may be larger than or equal to the third width W3. Also in this case, the same effects as those of the above embodiment can be achieved.

In the above embodiment, the third width W3 is larger than or equal to the first thickness T1, the second thickness T2, and the fourth width W4, and equal to or smaller than the first width W1, but the third width W3 may be smaller than the first thickness T1, the second thickness T2, and the fourth width W4. The third width W3 may be larger than the first width W1. Also in this case, the same effects as those of the above embodiment can be achieved.

As illustrated in FIG. 4, in the above embodiment, the third width W3 is equal to the fifth width W5, but the third width W3 may be different from the fifth width W5. The fourth width W4 is equal to the sixth width W6, but the fourth width W4 may be different from the sixth width W6.

### REFERENCE SIGNS LIST

1 coil device
10 first core
11 first side surface
12 second side surface
13 third side surface
14 fourth side surface
15 mounting surface
16 mounting facing surface
17 groove
170 bottom surface
171, 172 inner wall
20 second core
21 contact surface
30 first conductor
31 first body portion
310 first outer side surface
311 first inner side surface
312 first top surface
313 first bottom surface
32a, 32b first mounting portion
320 base end portion
321 curved portion
322 leg portion
40 second conductor
41 second body portion
410 second outer side surface
411 second inner side surface
412 second top surface
413 second bottom surface
42a, 42b second mounting portion
420 base end portion
421 curved portion
422 leg portion
50 magnetic coupling portion
60 to 62 gap
70 adhesive

What is claimed is:

1. A core device, comprising: a core having a mounting surface;
a first conductor including a first body portion extending along the mounting surface inside the core; and
a second conductor including a second body portion that extending along the mounting surface inside the core and facing the first body portion, wherein
the first body portion has a first side surface having a first thickness in a direction perpendicular to the mounting surface and a first main surface having a first width in a direction parallel to the mounting surface,
the second body portion has a second side surface having a second thickness in the direction perpendicular to the mounting surface and a second main surface having a second width in the direction parallel to the mounting surface, and
the second width is narrower than the first width in a direction in which the first body portion and the second body portion face each other.

2. The coil device according to claim 1, wherein
the first side surface and the second side surface are perpendicular to the mounting surface.

3. The coil device according to claim 1, wherein
the first conductor includes a first mounting portion continuous with the first body portion,
the second conductor includes a second mounting portion continuous with the second body portion, and
a cross-sectional area of the first mounting portion or the second mounting portion is larger than a cross-sectional area of the second body portion and is equal to or smaller than a cross-sectional area of the first body portion.

4. The coil device according to claim 3, wherein
the first mounting portion has a third width in an axial direction of the first body portion and a fourth width in the direction in which the first body portion and the second body portion face each other,
the first thickness, the second thickness, and the fourth width are equal,
the first thickness, the second thickness, and the fourth width are larger than the second width and equal to or smaller than the third width, and
the third width is larger than or equal to the first thickness, the second thickness, and the fourth width and equal to or smaller than the first width.

5. The coil device according to claim 3, wherein
the first mounting portion has a third width in an axial direction of the first body portion and a fourth width in the direction in which the first body portion and the second body portion face each other,
the second mounting portion has a fifth width in an axial direction of the second body portion and a sixth width in the direction in which the first body portion and the second body portion face each other,
the third width is equal to the fifth width, and
the fourth width is equal to the sixth width.

6. The coil device according to claim 1, wherein
the first body portion and the second body portion constitute a magnetic coupling portion magnetically coupled to each other, and
a center portion of the magnetic coupling portion is positioned at a center portion of the core in the direction in which the first body portion and the second body portion face each other.

7. The coil device according to claim 1, wherein
a ratio of the first width to the second width is 3:1 to 4:1.

8. The coil device according to claim 1, wherein
the first conductor includes a first mounting portion continuous with the first body portion and exposed from the core,
the second conductor includes a second mounting portion continuous with the second body portion and exposed from the core, and
the first mounting portion and the second mounting portion extend to a mounting surface side of the core while being separated from each other along the direction in which the first body portion and the second body portion face each other.

9. The coil device according to claim 8, wherein
the first mounting portion includes a first base end portion extending along the direction in which the first body portion and the second body portion face each other, and a first leg portion continuous with the first base end portion and extending toward the mounting surface,
the second mounting portion includes a second base end portion extending toward a side opposite to the first base end portion along the direction in which the first body portion and the second body portion face each other, and a second leg portion continuous with the second base end portion and extending toward the mounting surface,
the first mounting portion is curved in an L-shape from the first base end portion to the first leg portion, and
the second mounting portion is curved in an L-shape from the second base end portion to the second leg portion.
